(19) United States
(12) Patent Application Publication
(10) Pub. No.: US 2008/0310295 A1
(43) Pub. Date: Dec. 18, 2008

(54) METHODS FOR EXTRA APPENDING DATA IN A MULTIPLE LAYER DISC

(75) Inventors: Yen Ying Lai, Taipei County (TW); Chih Tai Cheng, Taipei County (TW); Yung Chih Hsu, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/762,030

(22) Filed: Jun. 12, 2007

(51) Int. Cl. G11B 3/70; G11B 5/84; G11B 7/26

(52) U.S. Cl. 369/284

(57) ABSTRACT

A method for extra appending data in a multiple layer disc is provided. The capacity of the data zone in the multiple layer disc is fixed, and each layer comprises a plurality of appended sessions. When multiple layer disc is mounted, it is determined whether data is appended in zones following a middle zone. If the data is appended in the zones following the middle zone, a first jump address is obtained from a table of extended contents to serve a start address of appending the data. Data is appended to the multiple layer disc. An end address of appending the data is recorded in the table of extended contents to serve a second jump address for a next appending operation.

### BACKGROUND OF THE INVENTION

1. Field of the Invention

The invention relates to a method for extra appending data in a fixed capacity of data zone, and in particular to a method for of extra appending data in a multiple layer disc with a fixed capacity of data zone.

2. Description of the Related Art

FIG. 1 is a schematic view showing data sections in a conventional double layer disc 100, such as DVD+R double layer disc, with a fixed capacity of data zone. The double layer disc 100 comprises a zero layer Layer_0 and a first layer Layer_1. The zero layer Layer_0 comprises an inner drive area 101, a lead-in zone 102, a data zone 103, a middle zone 104, and an outer drive area 105. The first layer Layer_1 comprises an inner drive area 111, a lead-out zone 112, a data zone 113, a middle zone 114, and an outer drive area 115. The inner drive area 101 further comprises a table of contents (TOC, not shown) recording information in the double layer disc 100, such as file contents.

Referring to FIG. 1, many blank zones outside of the outer drive areas 105 and 115 of the zero layer Layer_0 and the first layer Layer_1 can store data. The double layer disc 100 is, however, unable to use the blank zones because the double layer disc 100 has been written into the lead out zone 112 and the capacity of the data zone (that is the capacity of the data zones 103 and 113) is fixed.

### BRIEF SUMMARY OF THE INVENTION

An exemplary embodiment of a method for extra appending data in a multiple layer disc is provided. The capacity of the data zone in the multiple layer disc is fixed, and each layer comprises a plurality of appended sessions. The multiple layer disc comprises an inner drive area. The multiple layer disc is mounted. It is determined whether data is appended in zones following a middle zone. If the data is appended in the zones following the middle zone, a first jump address is obtained from a table of extended contents to serve a start address of appending the data. Data is appended to the multiple layer disc. An end address of appending the data is recorded in the table of extended contents to serve a second jump address for a next appending operation.

An exemplary embodiment of a method for reading data extra appended in a multiple layer disc is provided. The capacity of data zone in the multiple layer disc is fixed, and each layer comprises a plurality of appended sessions. First, a read command is received. A start address is determined according to start, end, and jump addresses of each session for reading the data, and data of the multiple layer disc is read.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view showing data sections in a conventional double layer disc;

FIG. 2 is a schematic view showing data sections in a disc according to an exemplary embodiment of the invention;

FIG. 3 is a table of extended contents TOEC according to the invention;

FIG. 4 is a table of the non-user address (NUA) according to the invention; and

FIG. 5 is a flow chart of an embodiment of a method for extra appending data to a fixed capacity of a data zone.

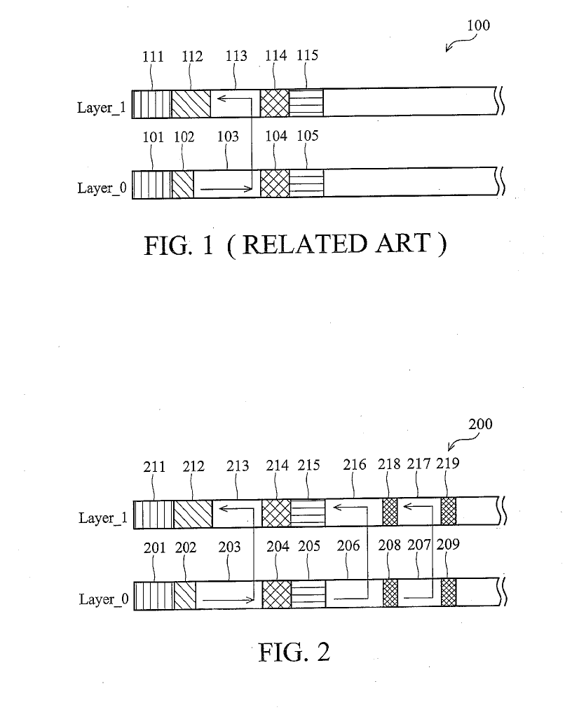

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Methods for extra appending data to the fixed capacity of a data zone are provided. FIG. 2 is a schematic view showing data sections in a disc 200, such as DVD+R, according to an exemplary embodiment. The capacity of data zone in the disc 200 is fixed. The disc 200 comprises a plurality of layers (a zero layer, a first layer, a second layer . . . ). In this embodiment, a DVD+R disc with two layers (a zero layer and a first layer) is given as an example. The invention is, however, not restricted to any type of disc or the number of layers. The disc 200 with two layers comprises a zero layer Layer_0 and a first layer Layer_1. The zero layer Layer_0 comprises an inner drive area 201, a lead-in zone 202, a plurality of data zones 203, 206, and 207, a middle zone 204, an outer drive area 205, and a plurality of closures 208 and 209. The first layer Layer_1 comprises an inner drive area 211, a lead-out zone 212, a plurality of data zones 213, 216, and 217, a middle zone 214, an outer drive area 215, and a plurality of closures 218 and 219.

Referring to FIG. 2, when an amount of data appended the first time is less than the capacity of disc, data can be appended continuously many times in the outer drive area 205 and a data reading operation is successfully performed even though data has been appended from the lead-in zone 202 to the lead-out zone 212 (the capacity of the data zone is fixed.). The data reading operation will be described in the following. In this embodiment, data is appended from the data zone 206 of the zero layer Layer_0 to the data zone 216 of the first layer Layer_1 the second time, and data is appended from the data zone 207 of the zero layer Layer_0 to the data zone 217 of the first layer Layer_1 the third time. Each appending operation after the second appending operation begins in zones following the closures. In this embodiment, three appending operations are given as an example, and the number of appending operations is not limited. Subsequent additional appending operations will be will be described in the following.

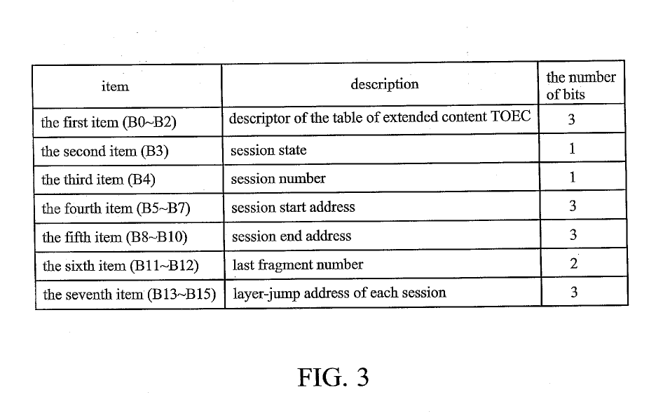

FIG. 3 is a table of extended contents TOEC. The table of extended contents TOEC is disposed in the inner drive area 201. The structure of the table of extended contents TOEC is smaller than a conventional table of contents TOC except for newly added layer-jump information for each appending operation. The added information is provided for recording a layer-jump address of the extra data appended in the subsequment appending operations. The table of extended contents TOEC comprises 16 bits B0 to B15 respectively belonging different items. The definitions of the bits B0 to B12 in the first six items are smaller a conventional table of contents TOC, and the bits B13 to B15 in the seventh item records the layer-jump address of the extra data appended in the following appending operations. The functions of the first six items are described in the following: the first item (B0 to B2) is a descriptor of the table of extended contents TOEC describing the table of extended contents TOEC; the second item (B3) indicates the session state; the third item (B4) indicates the session number; the fourth item (B5 to B7) indicates session start address; the fifth item (B8 to B10) indicates session end address; and sixth item (B11 to B12) indicates the last fragment number. It is will be described how to perform a new addressing operation by using the layer-jump address of each session recording in the seventh item to successfully read the data zones 206, 207, 216, and 217 in following appending operations.

Generally, a host and an operation system use a logic block address (LBA) for addressing. In practice, the logic block address (LBA) must to be transformed to a physical block address (PBA) when an optical disc drive performs an addressing operation, so that the subsequent access operations can be performed. The conventional transformation operation is effective for a session 1 (data zones 203 and 213), but not for the subsequent session 2 (data zones 206 and 216) and session 3 (data zones 207 and 217). In this embodiment, a temporary addressing operation is performed by the layer-jump address recorded in the seventh item with a non-user address (NUA) defined in the following. First, the logic block address (LBA) is transformed to the non-user address (NUA), and then the non-user address (NUA) is transformed to the physical block address (PBA), so that data of the sessions 2 and 3 is addressed. The detail is described in the following:

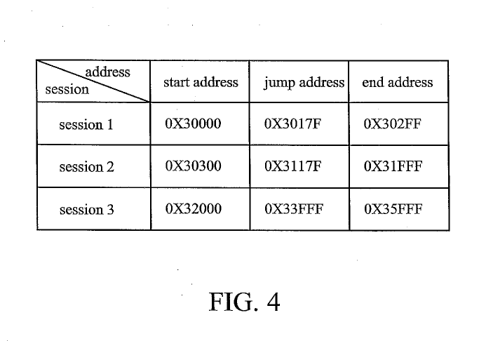

The logic block addresses (LAB) of each session are defined as follows: start, jump, and end addresses of the logic block address (LAB) of the session 1 are 0x000H (“H” representing the value is hexadecimal), 0x17FH, and 0x2FFH, respectively; start, jump, and end addresses of the logic block address (LAB) of the session 2 are 0x300H, 0x117FH, and 0x1FFFH, respectively; start, jump, and end addresses of the logic block address (LAB) of the session 3 are 0x2000H, 0x3FFFH, and 0x5FFFH, respectively. The corresponding non-user address (NUA) is obtained by adding the logic block address (LAB) and a predetermined value assumed as 0x30000. FIG. 4 is a table of the non-user address (NUA) according to the embodiment. It is assumed that there are two logic block addresses (LAB) the values of which are 0x1100 and 0x5500 respectively, and the transform operations are described in the following.

Transformation of a logic block address (LAB) of 0x1100H (“H” representing the value is hexadecimal) to a physical block address (PBA) comprises the following. First, the logic block address (LAB) of 0x1100H is added to the predetermined value of 0x30000H to obtain a non-user address (NUA) of 0x31100H. The obtained non-user address (NUA) of 0x31100H is then compared with an end address of the non-user address (NUA) of the session 1. When the obtained non-user address (NUA) is larger than the end address of the non-user address (NUA) of the session 1 (0x31100H>0x302FFH), the obtained non-user address (NUA) is not in the session 1. When the obtained non-user address (NUA) is smaller than the end address of the non-user address (NUA) of the session 2 (0x31100H<0x31FFFH), the obtained non-user address (NUA) is in the session 2. Finally, the capacity of session 1 ((0x30300H-0x30000H)/2=0x180H) is subtracted from the obtained non-user address (NUA) of 0x31100H to obtain a physical block address (PBA) of 0x30F80H. Note that, the obtained physical block address is in the zero layer because 0x31100H is smaller than 0x3117FH.

Transformation of a logic block address (LAB) of 0x5500H to a physical block address (PBA) comprises the following. First, the logic block address (LAB) of 0x5500H is added to the predetermined value of 0x30000H to obtain a non-user address (NUA) of 0x35500H, and then the obtained non-user address (NUA) of 0x35500H is compared with end addresses of the non-user addresses (NUA) of the sessions 1 and 2. When the obtained non-user address (NUA) is larger than the end addresses of the non-user addresses (NUA) of the sessions 1 and 2 (0x35500H>0x302FFH, and 0x35500H>0x31FFFH), the obtained non-user address (NUA) is in neither the session 1 nor the session 2. When the obtained non-user address (NUA) is smaller than the end address of the non-user address (NUA) of the session 3 (0x33300H<0x35FFFH), the obtained non-user address (NUA) is in the session 3. Finally, the capacity of sessions 1 and 2 ((0x32000H−0x30000H)/2=0x1000H) is subtracted from the obtained non-user address (NUA) of 0x35500H to obtain a value of 0x34500H and then obtain a physical block address (PBA) of ˜0x34500H by a negative operation. The negative operation is required because 0x3450H is larger than 0x33FFFH (ump address of the session 3) and the physical block address is in the first layer.

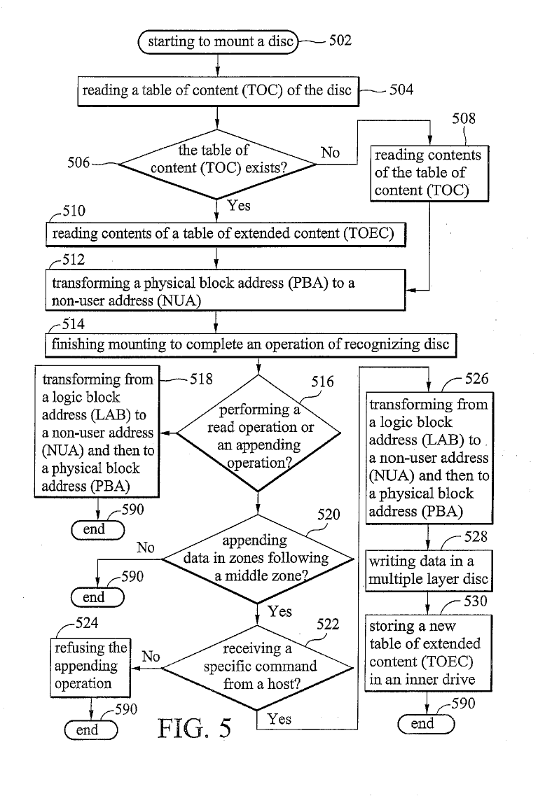

FIG. 5 is a flow chart of an embodiment of a method for extra appending data to the fixed capacity of data zone. The steps are:

Step 502: starting to mount a disc;

Step 504: reading a table of contents (TOC) of the disc;

Step 506: determining whether the table of contents (TOC) exists or not. If the table of contents (TOC) exists, proceed Step 510; if not, proceed Step 508;

Step 508: reading contents of the table of contents (TOC);

Step 510: reading contents of a table of extended contents (TOEC);

Step 512: transforming a physical block address (PBA) to a non-user address (NUA);

Step 514: finishing mounting to complete an operation of recognizing disc;

Step 516: determining if a read operation or an appending operation is performed. If the read operation is performed, proceed Step 518; if the appending operation is performed, proceed Step 520;

Step 518: transforming an address where data is read from a logic block address (LAB) to a non-user address (NUA), and then from the non-user address (NUA) to a physical block address (PBA) to complete an addressing operation and perform the read operation;

Step 520: determining whether data is appended in zones following a middle zone. If so, proceed Step 522; if not, proceed Step 590;

Step 522: determining whether a specific command from a host indicating that data can be appended in zones following a middle zone is received. If so, go to Step 526; if not, go to Step 524;

Step 524: refusing the appending operation;

Step 526: transforming an address where data is appended from a logic block address (LAB) to a non-user address (NUA), and then from the non-user address (NUA) to a physical block address (PBA) to complete an addressing operation and perform the read operation;

Step 528: writing data in a multiple layer disc;

Step 530: storing a new table of extended contents (TOEC) in an inner drive;

Step 590: end.

Compared with a conventional appending method, in the invention, when data has been appended from a lead-in zone to a lead-out zone (the capacity of the data zone is fixed), data can be appended continuously many times in the outer drive area. Moreover, reading or appending data can be performed via non-user addresses (NUA).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for extra appending data in a multiple layer disc, the capacity of data zone in the multiple layer disc being fixed, each layer comprising a plurality of appended sessions, and the multiple layer disc comprising an inner drive area, the method comprising:
mounting the multiple layer disc;
determining whether data is appended in zones following a middle zone;
obtaining a first jump address from a table of extended contents to serve a start address of appending the data if the data is appended in the zones following the middle zone;
appending the data to the multiple layer disc; and
recording an end address of appending the data in the table of extended contents to serve a second jump address for a next appending operation.

2. The method as claimed in claim 1, wherein in the step of obtaining the first jump address, a physical block address is transformed to a non-user address according to the first jump address.

3. The method as claimed in claim 1, wherein after the step of obtaining the first jump address, the method comprising:
transforming a logic block address where the data is desired to be appended to a non-user address; and
transforming the non-user address to a physical block address.

4. The method as claimed in claim 3, wherein the non-user address is obtained by adding the logic block address and a predetermined value, and the non-user address is transformed to the physical block address by determining which session and which layer of the multiple layer disc where the data is desired to be appended according to the start, end, and jump addresses of each session.

5. The method as claimed in claim 1, wherein before the step of appending data, the method comprising receiving an extra appending command to start appending.

6. The method as claimed in claim 1 further comprising storing the table of extended contents in the inner drive area.

7. A method for reading data extra appended in a multiple layer disc, the capacity of data zone in the multiple layer disc being fixed, and each layer comprising a plurality of appended sessions, the method comprising:
receiving a read command;
determining a start address according to start, end, and jump addresses of each session for reading the data; and
reading data of the multiple layer disc.

8. The method as claimed in claim 7 further comprising transforming a physical block address to a non-user address according to the jump address of each session.

9. The method as claimed in claim 7 further comprising:
transforming a logic block address wherein the data is desired to be read to a non-user address; and
transforming the non-user address to a physical block address.

10. The method as claimed in claim 9, wherein the non-user address is obtained by adding the logic block address desired to be read and a predetermined value, and the non-user address is transformed to the physical block address by determining which session and which layer of the multiple layer wherein disc the data is desired to be read according to the start, end, and jump addresses of each session.
